(19) United States
(12) Patent Application Publication
(10) Pub. No.: US 2024/0306524 A1
(43) Pub. Date: Sep. 19, 2024

(54) Output Unit, Agricultural Implement Comprising a Plurality of Such Output Units, and Method of Operating an Agricultural Implement

(71) Applicant: Väderstad Holding AB, Väderstad (SE)

(72) Inventors: Bengt Sandberg, Vikingstad (SE); Rune Rommedahl, Ljungsbro (SE); Crister Stark, Väderstad (SE)

(21) Appl. No.: 18/576,425

(22) PCT Filed: Jul. 4, 2022
(86) PCT No.: PCT/SE2022/050677

§ 371 Date: Jan. 4, 2024

(30) Foreign Application Priority Data
Jul. 5, 2021 (SE) 2150880-9

(51) Int. Cl. A01B 49/06; A01B 63/00; A01C 5/06; A01C 7/12

(52) U.S. Cl. CPC A01B 49/06; A01B 63/008; A01C 5/064; A01C 5/068; A01C 7/12

(57) ABSTRACT

An output unit for an agricultural implement, for feeding granular material to the ground over which the agricultural implement (1) is travelling, comprises a unit frame (211, 311), a seed furrow-opener (2111, 3132) supported by the unit frame, a depth regulator (212, 312) supported by the unit frame and used for controlling a work depth for the seed furrow-opener (2111, 3132), and an adjustment device for adjusting a relative height position between the depth regulator and the seed furrow-opener, such that a work depth for the seed furrow-opener is adjustable. The adjustment device is configured such that the depth regulator is adjustable relative to the seed furrow-opener between a work position, in which a lower portion of the depth regulator is located at a higher vertical level than a lower portion of the seed furrow-opener, and a field lift position, in which a lower portion of the depth regulator is located at a lower vertical level than a lower portion of the seed furrow-opener.

### TECHNICAL FIELD

This document discloses an output unit, such as a furrow opener or a row unit, for an agricultural implement, an agricultural implement comprising a plurality of such output units, and a method of operating an agricultural implement.

The concepts disclosed in this document are used in particular in connection with adjustment of the work depth for output units of agricultural implements.

### BACKGROUND

Agricultural implements for sowing, which comprise a plurality of output units, such as row units or furrow openers, which can each comprise a seed furrow-opener, a depth regulator, a sowing tube and a seed furrow-closing device, are known. Such agricultural implements can also comprise some form of pressure means for pressing down seed placed in an opened seed furrow.

Such output units are common in so-called “precision seed drills” or “planters”, i.e. seed drills which place each seed at a predetermined distance from an adjacent seed, but also in seed drills with volumetric metering, i.e. seed drills that are used for cereals.

One consideration in the context of seed drills which use a large number of furrow openers is that, when turning sharply with the implement, for example at headlands, the agricultural implement and in particular the furrow openers are subjected to considerable lateral forces which, in the worst case, can cause damage to the agricultural implement.

A further consideration, particularly in the context of seed drills which use a large number of disc shares, is the weight of the furrow opener assembly, which has to be taken into account in the design of lifting mechanisms and which affects the speed at which lifting can be carried out.

In addition, there is a risk of a negative load on the towing vehicle, which can lead to the back wheels of the towing vehicle lifting.

Moreover, lifting of a number of heavy implements leads to increased weight on the wheels on which the agricultural implement bears when turning, which in turn gives rise to denser packing of the soil on which the wheels are rolling.

There is therefore a need for an agricultural implement that has improved manoeuvrability.

### SUMMARY

One object of this document is therefore to provide an agricultural implement having improved manoeuvrability.

A further object is to provide an output unit which facilitates the operation of the agricultural implement and in particular the manoeuvring thereof.

The invention is defined by the attached independent patent claims. Embodiments are set forth in the attached dependent patent claims, in the description that follows and in the accompanying drawings.

According to a first aspect, an output unit for an agricultural implement, for feeding granular material to the ground over which the agricultural implement is travelling, is provided, comprising a unit frame, a seed furrow-opener supported by the unit frame, a depth regulator supported by the unit frame and used for controlling a work depth for the seed furrow-opener, and an adjustment device for adjusting a relative height position between the depth regulator and the seed furrow-opener, such that a work depth for the seed furrow-opener is adjustable. The adjustment device is configured such that the depth regulator is adjustable relative to the seed furrow-opener between a work position, in which a lower portion of the depth regulator is located at a higher vertical level than a lower portion of the seed furrow-opener, and a field lift position, in which a lower portion of the depth regulator is located at a lower vertical level than a lower portion of the seed furrow-opener.

The output unit can be a sowing unit, a row unit or similar.

The seed furrow-opener can comprise one or more disc tools, such as a single or a double disc share, or a fixed seed furrow-opener, such as a towing share, cutter share, blade share or cultivator share or similar, or a combination thereof.

The unit frame is a part which is mounted movably, for example pivotably, on an implement frame of an agricultural implement and which supports the components that form the output unit. The unit frame can typically be pivotably attached to the implement frame of the agricultural implement, either via an individual actuator or via a synchronizing arrangement which jointly controls a plurality of unit frames relative to the implement frame.

The depth regulator can comprise a depth regulator wheel, or another corresponding part for such contact against the ground, such that some of the ground contact force of the output unit is taken up and the penetration of the seed furrow-opener into the ground can be limited.

In the work position, the output unit is lowered and the seed furrow-opener is in engagement with the ground.

In a field lift position, the ground-engaging tools of the agricultural implement are raised from the ground in order to avoid ground engagement and in order thereby to facilitate turning at headlands. For example, a “negative work depth” can then be obtained.

In a transport position, the output units can be lifted/pivoted higher up and, in the case of implements which allow this, possible side sections can be folded in to reduce the width of the implement.

By adjusting the depth regulator such that a negative work depth is obtained, it is possible to let the depth regulator take up some or all of the weight of the output unit, and possibly also some or all of the weight of the agricultural implement, which reduces the risk of negative hook load on the towing vehicle and also reduces lateral forces that would otherwise occur on, for example, the seed furrow-opener when the agricultural implement turns sharply, as often happens at a headland.

The depth regulator can comprise a depth regulator wheel which is supported rotatably on a depth regulator arm, the latter being supported rotatably by the unit frame.

The seed furrow-opener can comprise a seed disc, which is supported rotatably on the unit frame.

The depth regulator can comprise a depth regulator wheel which, seen in projection on a vertical plane containing a work direction, overlaps the seed furrow-opener.

The output unit can further comprise a pressure device, which is arranged directly behind the material outlet, seen in the direction of travel, in order to receive and/or press the material to the ground.

The pressure device can be connected to the adjustment device, preferably via a resilient link, such that a position of the pressure device is adjustable.

The output unit can further comprise a closing device, which is arranged behind the material outlet, seen in the work direction, in order to cover material fed via the material outlet.

The closing device can be connected to the adjustment device, preferably via a resilient link, such that a position of the closing device is adjustable.

The pressure device and the closing device can be fixedly arranged relative to each other.

The adjustment device can be configured to adjust the material outlet such that the delivery point is positioned closer to a seed furrow bottom at a smaller work depth than at a greater work depth.

The material outlet can be attached so as to be movable relative to the unit frame, preferably pivotable about an axis that is parallel to a pivot axis.

The depth regulator wheel can be arranged substantially directly behind the seed furrow-opener, seen in a work direction of the output unit.

The adjustment device can comprise an actuator, which is supported by the unit frame and which acts between the unit frame and the depth regulator arm.

According to a second aspect, an agricultural implement is provided comprising an implement frame and a plurality of output units according to any of the preceding claims, which are movably arranged along at least one transverse frame portion of the implement frame.

The agricultural implement can comprise a control unit, which is configured to control the adjustment device in order to switch between said work position and said field lift position.

By providing a control unit and/or a synchronizing arrangement, it is possible for the depth regulators of a plurality of output units to be controlled individually or in groups, such that the adjustment between work position and field lift position can be controlled from, for example, the control cabin of a towing vehicle.

An output unit being arranged movably relative to the implement frame signifies that the unit frame of the output unit is mounted movably, in particular pivotably or displaceably, on the implement frame. The unit frame can, for example, be mounted on the implement frame via a hinge or a parallel linkage.

According to a third aspect, a method of operating an agricultural implement is provided, which method comprises providing an output unit for feeding granular material to the ground over which the agricultural implement is travelling, which comprises a unit frame, a seed furrow-opener supported by the unit frame, a depth regulator, for controlling a work depth for the seed furrow-opener, and a material outlet defining a delivery point at which the granular material leaves the material outlet. The method can comprise adjusting the depth regulator relative to the seed furrow-opener such that a lower portion of the depth regulator is located at a lower vertical level than a lower portion of the seed furrow-opener, wherein a negative work depth is obtained.

The method can comprise driving across field while metering with the aid of the output unit, the output unit being located in a work position in which a lower portion of the depth regulator is located at a higher vertical level than a lower portion of the seed furrow-opener, stopping the metering when the agricultural implement is located in a first work direction, carrying out said adjustment to the negative work depth, turning the agricultural implement such that it assumes a second work direction, which differs by at least 90 degrees, seen in a horizontal plane, from the first work direction, switching the output unit to the work position, and starting the metering when the agricultural implement is located in the second work direction.

The negative work depth can be obtained at field lift of the agricultural implement.

The adjustment of the work depth can be carried out with the aid of a central adjustment mechanism, common to the agricultural implement, for adjusting the work depth.

The adjustment of the work depth can be carried out by acting substantially simultaneously on the respective actuator arranged on each output unit.

### BRIEF DESCRIPTION OF THE DRAWINGS

FIG. 1 shows a schematic perspective view of an agricultural implement in the form of a seed drill with a number of furrow openers.

FIGS. 2a-2c show a furrow opener viewed obliquely from the rear, from above and in an exploded view, respectively.

FIG. 3 shows a pair of interconnected furrow openers, viewed obliquely from the rear.

FIGS. 4a-4b show a set of furrow openers viewed in perspective obliquely from the rear, and one of said furrow openers viewed from the side in a first work position.

FIGS. 5a-5b show a set of furrow openers viewed in perspective obliquely from the rear, and one of said furrow openers viewed from the side in a second work position.

FIGS. 6a-6b show a furrow opener viewed from the side in two different positions.

FIGS. 7a-7b show an alternative embodiment of a furrow opener in two different positions.

### DETAILED DESCRIPTION

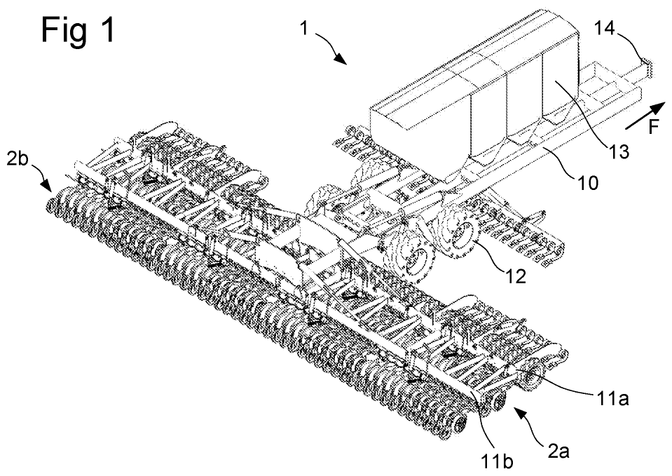

FIG. 1 shows an agricultural implement 1 in the form of a seed drill, which comprises a frame having at least one longitudinal frame portion 10 and at least one transverse frame portion 11a, 11b. In the example shown, the seed drill has a front transverse frame portion 11a, which supports a set 2a of front furrow openers, and a rear transverse frame portion 11b, which supports a set 2b of rear furrow openers.

The agricultural implement 1 has at least one wheel 12, a seed container 13 and a draw coupling 14, by means of which the agricultural implement 1 can be coupled to a towing vehicle, such as a tractor, so as to be drawn in a direction of travel F.

In the example shown, the agricultural implement is formed by a seed drill, especially a seed drill for volumetric feeding of seed. Such seed drills are traditionally used for sowing cereals, such as wheat, oat, rye or corn.

The concepts disclosed herein can also be applied to precision seed drills and to other types of machines for feeding material, especially granular material, to the ground over which the agricultural implement is travelling.

The frame of the agricultural implement 1 can comprise one or more side portions, which can be foldable between a work position and a transport position. For example, the agricultural implement can have two, three, four or five portions which, in the work position, are located next to one another, and substantially in the same plane, and can each support a plurality of ground-engaging tools, such as output units (furrow openers, row units, fertilizer openers), but also levelling tools, flattening tools, cultivator tines, etc.

Such side portions can be foldable about one or more axes which are substantially parallel to the direction of travel and preferably horizontal.

The agricultural implement can be configured such that all the support wheels are arranged in front of the row units, seen in the direction of travel. A plurality of row units can thus be arranged furthest back on the agricultural implement.

Thus, the transverse frame portions 11a, 11b can be divided into a plurality of sections, where each section supports a plurality of output units.

Furthermore, the frame of the agricultural implement can comprise one or more front portions and/or rear portions which are pivotable or foldable in relation to a central portion. For example, a front portion can comprise levelling tools, and a rear portion can comprise compacting tools, such as some form of roller.

In agricultural implements with two or more side portions, each side portion can have a front portion and/or a rear portion which can be foldable with the respective side portion.

The agricultural implement shown in FIG. 1 has a large number of furrow openers 21a, 21b (FIG. 3), which are arranged along two separate rows in the direction of travel F. The furrow openers 21a in a front set 2a can be offset laterally in relation to the furrow openers 21b in a rear set 2b, such that a greater row density can be obtained than would be allowed by the width of the output units if all of the output units were located on the same row. The offset can be of the order of 40-60% of a distance between two adjacent output units in any of the rows.

All of the furrow openers 21a in the front set 2a can be substantially identical in design.

In the same way, all of the furrow openers 21b in the rear set 2b can be substantially identical in design.

Furthermore, the furrow openers 21b in the rear set 2b can be substantially designed in mirror image in relation to the furrow openers 21a in the front set 2a.

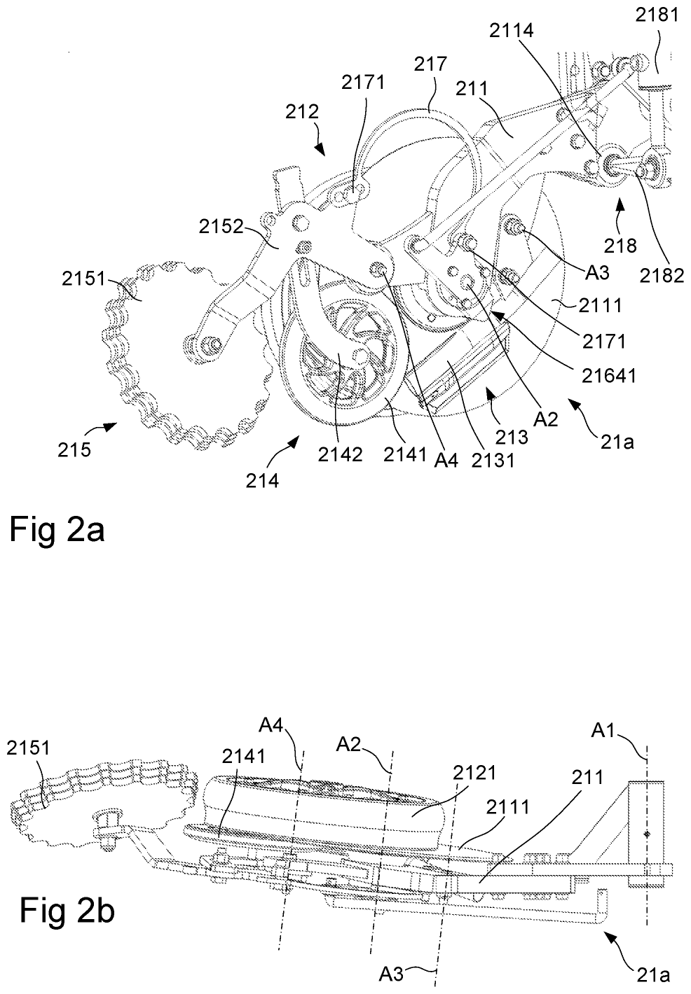

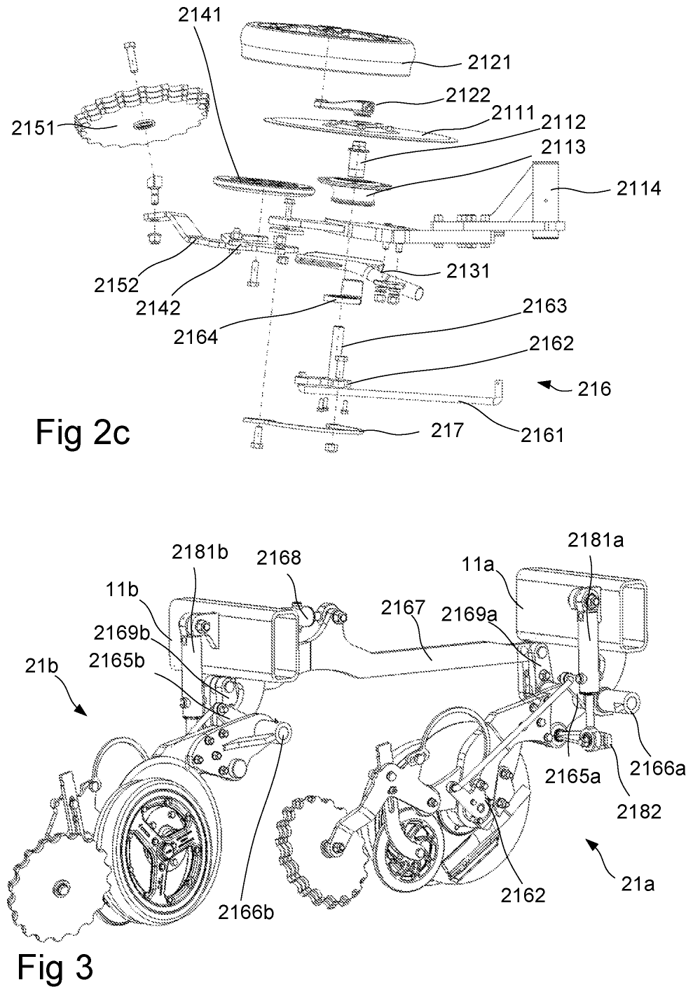

FIGS. 2a-2b show an example of an output unit in the form of a furrow opener 21a, which is pivotably attachable to a frame portion 11a (FIG. 3) of the agricultural implement 1. The furrow opener 21a has a unit frame 211, which can have a mainly two-dimensional, and possibly elongate, extent. At a front portion of the unit frame 211, there is a frame mount 2114 for pivotable attachment relative to the frame portion 11a, 11b, such that the furrow opener 21 is pivotable relative to the frame portion 11a, 11b about a first pivot axis A1. The first pivot axis A1 can be substantially horizontal and parallel to the frame portion 11a, 11b. At the frame mount 2114, the output unit 21a, 21b can be freely pivotably supported relative to the frame portion 11a, 11b.

At a distance from the frame mount 2114, attachments can be present for seed discs 2111, depth regulators 212, press wheel devices 214 and closing device devices 215, where such devices are present.

An attachment for seed discs 2111 can be arranged at a rear and lower portion of the unit frame 211. Attachments for press wheel device 214 and/or closing device 215 can be arranged at a rear and upper portion of the unit frame 211.

The seed disc 2111 can be rotatably attached to the unit frame 211, such that it is rotatable about a second pivot axis A2, which can form an acute angle with the first pivot axis A1. The angle between the first and second pivot axes A1, A2 can be approximately 1-30 degrees, preferably approximately 1-20 degrees or approximately 1-10 degrees, seen in a horizontal plane.

With reference to FIG. 2c, the seed disc 2111 can be freely rotatably attached relative to the unit frame 211 via a bearing hub 2113. The bearing hub 2113 can be received in a recess or in a through-hole in the unit frame 211.

The depth regulator 212 can comprise a depth regulator wheel 2121, which can be freely rotatably supported at a free end of a depth regulator arm 2122. The depth regulator arm can be pivotable about the second pivot axis A2 and fixedly connected to an adjustment axle 2163, such that the pivoting position of the depth regulator arm 2122 is adjustable with the aid of an adjustment device 216.

The adjustment device 216 can comprise the adjustment axle 2163, which is pivotably arranged relative to the unit frame 211, such that the adjustment device 216 is pivotable about the second pivot axis A2.

An adjustment part 2162 can be fixedly connected to the adjustment axle 2163, such that the adjustment part 2162 and the depth regulator arm 2122 are fixedly arranged relative to each other and pivotable about the second pivot axis A2. The adjustment part 2162 can comprise a lever arm, at which an adjustment link 2161 is pivotably connected for controlling the adjustment device 216.

The adjustment axle 2163 can extend through the bearing hub 2113, such that the adjustment part 2162 is located on one axial side of the bearing hub 2113 and such that the depth regulator arm 2122 is located on the second, opposite axial side of the bearing hub 2113.

The adjustment part 2162 can comprise a cam part 2164, which can be fixable to the adjustment part 2162, such that the cam part 2164 and the adjustment part 2162 are fixedly arranged with respect to each other, wherein the cam part 2164 is pivotable together with the adjustment part 2162 about the second pivot axis A2.

A material outlet 213 can be movably attached relative to the unit frame 211, preferably pivotably about an axis A3 which can be parallel to the second pivot axis A2. The material outlet 213 can be connected via a pipe or a hose to a material container 13, possibly via a distributor device, designed to distribute material from the container 13, with the aid of an air flow, to a plurality of output units 21a, 21b. The material outlet 213 can comprise a pipe 2131, such as a sowing pipe.

The cam part 2164 can have a cam surface 21641 in slidable engagement with a surface 2137, facing the cam part, of the material outlet 213, such that the position of the material outlet is limited upwardly by the cam part. The cam part can have such a shape that a location for an upper limitation position for the material outlet is dependent on the pivoting position of the cam part about the second pivot axis A2.

A distance between the second pivot axis A2 and a contact point between the cam part 2164 and the material outlet 213 can thus be set by pivoting the cam part 2164 about the second pivot axis A2.

The cam surface 21641, or the entire cam part 2164, can be made of a soft material, such as polymer material, in order to reduce wear on the material outlet 213.

The pressure device 214 can comprise a press wheel 2141, which can be supported freely rotatably on a press wheel arm 2142. The press wheel 2141 can be positioned directly behind the material outlet 213, seen in the direction of travel, such that material that is output is caught by the press wheel 2141 and pressed into contact with the soil.

The press wheel arm 2142 can be movably, in particular pivotably, attached to the unit frame 211, such that the height position of the press wheel in relation to the unit frame 211 and/or in relation to the depth regulator wheel is adjustable.

Furthermore, the press wheel arm 2142 can be movably, in particular pivotably, attached to the unit frame 211, such that the position of the press wheel along the direction of travel F in relation to the unit frame 211 and/or in relation to the material outlet 213 is adjustable.

The closing device 215 can comprise a closing wheel 2151, which can be supported freely rotatably on a closing arm 2152. The closing wheel 2151 can be arranged to rotate about an axis which forms an acute angle with the first pivot axis A1, and which also forms an acute angle with a horizontal plane, such that the closing wheel has a side whose surface normal points obliquely upwards and forwards, so that it can move soil laterally in order to cover a seed furrow that has been formed by the seed disc 2111.

The closing arm 2152 can be movably, in particular pivotably, attached to the unit frame 211, such that the height position of the closing wheel in relation to the unit frame 211 and/or in relation to the depth regulator wheel is adjustable.

In the example shown, the press wheel arm 2142 and the closing arm 2152 are fixedly connected to each other and pivotable relative to the unit frame about a fourth pivot axis A4, which can be parallel to the second pivot axis A2.

FIG. 3 shows a pair of furrow openers 21a, 21b, which have a common control arrangement for controlling a work depth.

The control arrangement can comprise a depth control cylinder 2168, which is connected to a control link 2167 which, via a control link lever arm 2169, acts on one or more control shafts 2166a, 2166b.

The depth control cylinder 2168 can be a hydraulic cylinder, which can act between a frame portion, here a rear transverse frame portion 11b, and the control link 2167. In the example shown, the control link 2167 extends between a rear control link lever arm 2169, associated with a rear control shaft 2166b, and a front control link lever arm 2169, associated with a front control shaft 2166a.

Each control link lever arm 2169a, 2169b is, at a proximal portion thereof, fixedly attached to the control shaft 2166a, 2166b, wherein the control link 2167 is pivotably attached to a distal portion of the control link lever arm 2169a, 2169b.

A control lever arm 2165 associated with the furrow opener 21a, 21b is fixedly arranged on the control shaft 2166a, 2166b and connected to the adjustment link 2161. Each control lever arm 2165, 2165a, 2165b is, at a proximal portion thereof, fixedly attached to the control shaft 2166, wherein the adjustment link 2161 is pivotably attached to a distal portion of the control lever arm 2165, 2165a, 2165b.

At least one of the press wheel arm 2142 and the closing arm 2152 can be connected to the adjustment part 2162 via a link part 217, which here is formed as a spring.

The spring can have a spring mount 2171 on the adjustment part 2162, which spring mount is located at a distance from the second pivot axis A2, such that a lever arm is obtained.

Furthermore, the spring can have a spring mount 2172 on the press wheel arm 2142 or on the closing arm 2152, which spring mount is located at a distance from the fourth pivot axis A4.

In the example shown, the link part 217 is shown as a spring, which can be compressed or expanded along a line between the spring mounts. Thus, a certain relative movement between the closing wheel/press wheel and the adjustment device 216 can be allowed. The type of spring can be selected on the basis of the space that is available in the structure.

Operating the depth control cylinder 2168 causes the control link 2167 to provide substantially the same movement of the front and rear control link lever arms 2169. Thus, the same pivoting movement is also provided for the front and rear control shafts 2166a, 2166b.

Pivoting a control shaft 2166a, 2166b causes pivoting of the respective control lever arm 2165 associated with the furrow opener 21a, 21b. A control shaft can thus be operated for controlling the work depth of a plurality of furrow openers arranged along the control shaft and connected thereto.

The pivoting movement of the control lever arm 2165 is transferred to a pivoting movement of the adjustment part 2162 with the aid of the adjustment link 2161.

The furrow openers 21a, 21b can be freely pivotably supported on the control shaft 2166a, 2166b. A ground pressure cylinder 2181a, 2181b operating between a frame portion, here the respective transverse frame portion 11a, 11b, and at least one furrow opener 21a, 21b can be arranged to adjust a pressure that the furrow opener is to exert on the ground.

In the arrangement shown, each ground pressure cylinder 2181a, 2181b is arranged to control ground pressure for two adjacent furrow openers 21a, 21b, by means of the ground pressure cylinder 2181a, 2181b acting on a transverse link 2182 that extends between the adjacent furrow openers.

The transverse link 2182 can be pivotably attached to the respective furrow opener, such that the adjacent furrow openers can have different pivoting positions about the control shaft 2166a, 2166b.

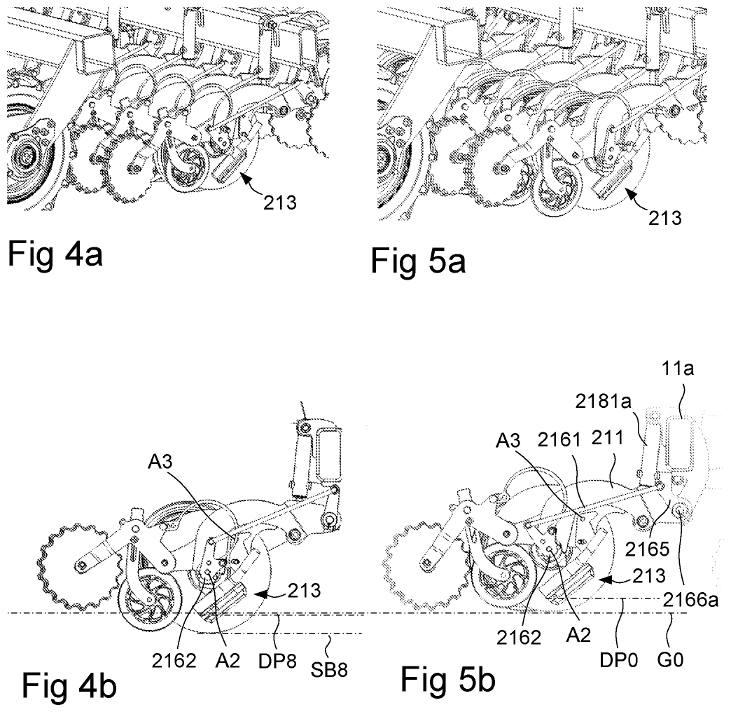

FIGS. 4a-4b show a furrow opener 21a in a first work position, where a great work depth is provided. As an example, a work depth of 8 cm is shown.

FIGS. 5a-5b show a furrow opener 21a in a second position, where a small work depth is provided. As an example, a work depth of 0 cm is shown.

In FIGS. 4a-4b and 5a-5b, the “ground level”, i.e. the level to which the depth regulator wheel 2121 is set, is indicated by reference sign G0. The delivery point for the material outlet is indicated by reference sign DP8 in FIGS. 4a-4b and by reference sign DP0 in FIGS. 5a-5b.

As will best be seen from a comparison of FIG. 4b and FIG. 5b, the adjustment part 2162 is located, in FIG. 4b, in a first pivoting position and, in FIG. 5b, in a second pivoting position.

In the first pivoting position (FIG. 4b), which is intended for a great work depth, the distance between the second pivot axis A2 and the material outlet 213 is minimal. Thus, the material outlet is allowed to adopt a position which places the delivery point DP8 as high up as possible in relation to the bottom SB8 of the seed furrow.

In this position, the material outlet is therefore drawn as high up as possible, so as not to engage with the ground, wherein the wear on the material outlet is minimized, as also is the friction of the material outlet against the ground, and the consequent traction force requirement.

In the second pivoting position (FIG. 5b), which is intended for small work depths, the distance between the second pivot axis A2 and the material outlet 213 is maximal. Thus, the material outlet is caused to assume a position which places the delivery point DP0 as low down as possible in relation to the bottom of the seed furrow, which in FIG. 5b coincides with the ground surface G0.

In this position, the material outlet is therefore as low down as possible, so as to engage with the ground in order to remove such soil as the seed furrow-opener has not successfully removed, thereby ensuring that a suitable furrow is formed.

As can be seen in FIGS. 4b and 5b, the material outlet 213 is pivotably attached to the unit frame 211, such that pivoting is possible about the third pivot axis A3.

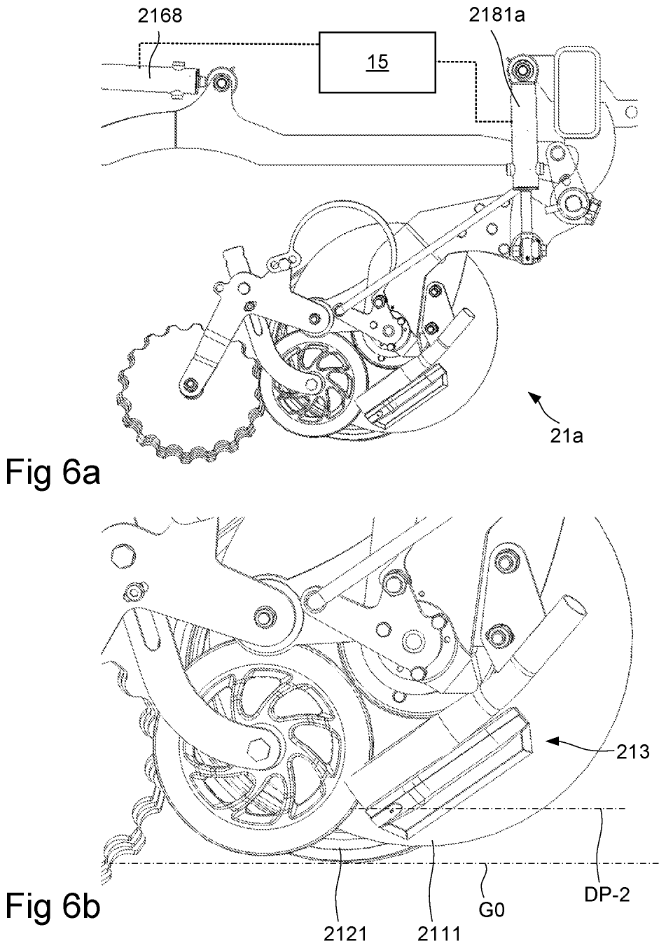

FIGS. 6a-6b show a further pivoting position for the adjustment part and the material outlet, in which position the depth regulator wheel 2121 is adjusted such that its lower portion is located at a lower vertical level than a lower portion of the seed disc 2111, wherein a “negative work depth” is provided. The seed disc 2111 is thus withdrawn from the ground, such that the greater part of the ground pressure of the furrow opener is taken up by the depth regulator wheel 2121.

Such a position with a negative work depth can be used, for example, when operating the agricultural implement with the output units folded down to the work position, with the seed furrow-opener in the position not engaging with the ground, but without feeding of material, for example when turning at headlands or during other shorter movements between work regions.

The negative work depth, i.e. the height difference between the lower portion of the seed furrow-opener and the lower portion of the depth regulator, can be of the order of approximately 5-100 mm, preferably approximately 5-50 mm or approximately 5-20 mm.

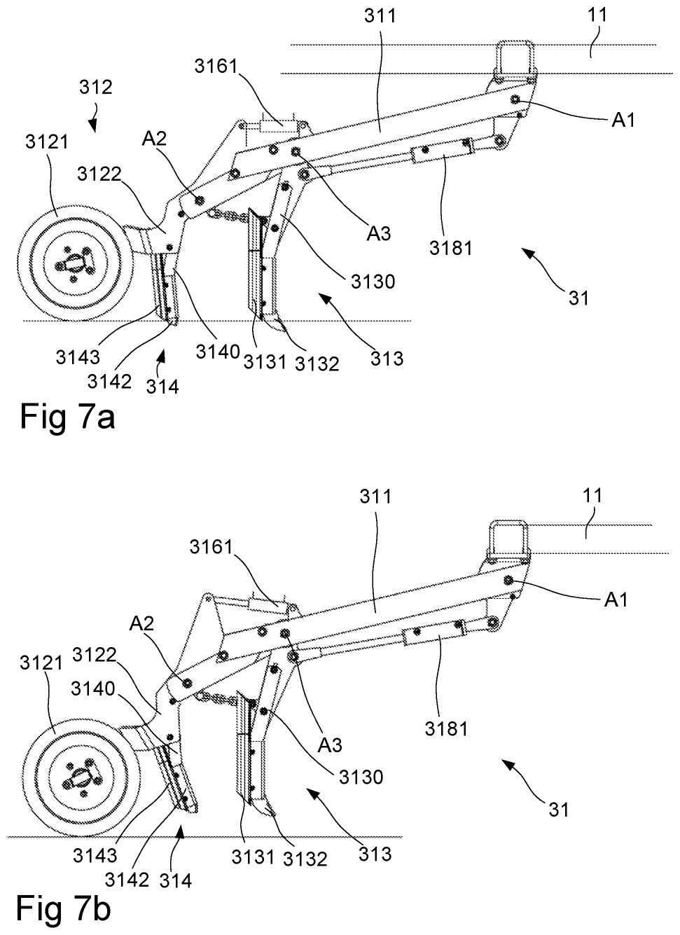

FIGS. 7a-7b show an alternative embodiment of an output unit 31, which can also be arranged rotatably relative to an implement frame 11.

The output unit 31 comprises a unit frame 311, which can be arranged pivotably relative to the unit frame 11 about a first axis A1. The unit frame 311 can be designed as an arm with a proximal end at the first axis A1 and with a free, distal end.

The unit frame 311 moreover has a depth regulator 312, which can comprise a depth regulator arm 3122 which supports a depth regulator wheel 3121. The depth regulator arm 3122 can be mounted pivotably on the unit frame 311 about a second axis A2. A depth adjustment device can comprise an actuator 3161 for adjusting a pivoting position between the unit frame 311 and the depth regulator arm 3122.

The unit frame 311 supports a first material outlet 313, which can comprise a first material outlet arm 3130 which can be mounted pivotably on the unit frame 311 about a third axis A3, a first pipe 3131 and a first seed furrow-opener 3132, which can have the form of a furrow opener or a disc opener.

The unit frame 311 can support a second material outlet 314, which can comprise a material outlet arm 3140 which can be mounted pivotably on the unit frame 311 about an axis A3, a pipe 3141 and a seed furrow-opener 3142, which can have the form of a furrow opener or a disc opener.

For example, one of the material outlets 313, 314 can be used to output seed and the other to output fertilizer and/or pesticide. Alternatively, the material outlets 313, 314 can be used to output supplementary crops.

The output unit 31 can have an arrangement for controlling ground pressure, which arrangement can comprise an actuator 3181 that can be arranged as a parallelogram with the unit frame 311. The actuator 3181 can also be used for lifting the whole output unit 31 relative to the implement frame 11.

As is shown in FIG. 7b, the depth adjustment device, in a manner corresponding to that shown in FIG. 5b, can be operated to set a negative work depth, wherein at least one but preferably both material outlets are disengaged from the ground.

A control unit 15 and/or a synchronizing arrangement can be arranged to control the depth regulators of a plurality of output units individually and/or in groups, such that the adjustment between the work position and the field lift position can be controlled from, for example, the control cabin of the towing vehicle. The control unit 15 can comprise electronics and software for control purposes and force converters for operating purposes. For example, the control unit can comprise a processing unit with an interface for controlling the hydraulics of the agricultural implement, such as the actuators 2168 for depth regulation and 2181a, 2181b (FIG. 6a); 3161, 3181 (FIGS. 7a-7b) for ground pressure, as shown in FIG. 6a.

It will be appreciated moreover that the control unit 15 can be provided in its entirety on the agricultural implement 1. Alternatively, at least parts of the control unit 15 can be provided in a towing vehicle, for example in a central control unit for the equipment.

By means of the control unit 15, it is possible to control the setting of the depth regulators 2121 centrally, either through inputs by a user or as part of the automated control routines, for example for turning at headlands.

It will also be appreciated that what has been described here is just one example of how output units and central control/synchronization systems can be designed and that the invention may be applied to any output unit whose depth regulator permits adjustment to a negative work depth.

1-19. (canceled)

20. Output unit for an agricultural implement, for feeding granular material to the ground over which the agricultural implement is travelling, comprising:
a unit frame,
a seed furrow-opener supported by the unit frame,
a depth regulator supported by the unit frame and used for controlling a work depth for the seed furrow-opener, and
an adjustment device for adjusting a relative height position between the depth regulator and the seed furrow-opener, such that a work depth for the seed furrow-opener is adjustable,
wherein the seed furrow-opener comprises a seed disc, which is supported rotatably on the unit frame,
wherein the depth regulator comprises a gauge wheel which, seen in projection on a vertical plane containing a work direction, overlaps the seed furrow-opener, and
wherein the adjustment device is configured such that the depth regulator is adjustable relative to the seed furrow-opener between a work position, in which a lower portion of the depth regulator is located at a higher vertical level than a lower portion of the seed furrow-opener, and a field lift position, in which a lower portion of the depth regulator is located at a lower vertical level than a lower portion of the seed furrow-opener.

21. Output unit according to claim 20, wherein the depth regulator comprises a gauge wheel which is supported rotatably on a depth regulator arm, the latter being supported rotatably by the unit frame.

22. Output unit according to claim 20, further comprising a pressure device, which is arranged directly behind a material outlet, seen in the direction of travel, in order to receive and/or press the material to the ground.

23. Output unit according to claim 22, wherein the pressure device is connected to the adjustment device, preferably via a resilient link, such that a position of the pressure device is adjustable.

24. Output unit according to claim 20, further comprising a closing device, which is arranged behind the material outlet, seen in the work direction, in order to cover material fed via the material outlet.

25. Output unit according to claim 24, wherein the closing device is connected to the adjustment device, preferably via a resilient link, such that a position of the closing device is adjustable.

26. Output unit according to claim 22, wherein the pressure device and the closing device are fixedly arranged relative to each other.

27. Output unit according to claim 20, wherein the adjustment device is configured to adjust the material outlet such that a delivery point is positioned closer to a seed furrow bottom at a smaller work depth than at a greater work depth.

28. Agricultural implement comprising an implement frame and a plurality of output units according to claim 20, which are movably arranged along at least one transverse frame portion of the implement frame.

29. Agricultural implement according to claim 28, further comprising a control unit, which is configured to control the adjustment device in order to switch between said work position and said field lift position.

30. Method of operating an agricultural implement, which method comprises:
providing an output unit for feeding granular material to the ground over which the agricultural implement is travelling, which comprises a unit frame, a seed furrow-opener supported by the unit frame, a depth regulator, for controlling a work depth for the seed furrow-opener, and a material outlet defining a delivery point at which the granular material leaves the material outlet,
wherein the seed furrow-opener comprises a seed disc, which is supported rotatably on the unit frame, and
wherein the depth regulator comprises a gauge wheel which, seen in projection on a vertical plane containing a work direction, overlaps the seed furrow-opener,
characterized by
adjusting the depth regulator relative to the seed furrow-opener such that a lower portion of the depth regulator is located at a lower vertical level than a lower portion of the seed furrow-opener, wherein a negative work depth is obtained.

31. Method according to claim 30, which method comprises:
driving across field while metering with the aid of the output unit, the output unit being located in a work position in which a lower portion of the depth regulator is located at a higher vertical level than a lower portion of the seed furrow-opener,
stopping the metering when the agricultural implement is located in a first work direction,
carrying out said adjustment to the negative work depth,
turning the agricultural implement such that it assumes a second work direction, which differs by at least 90 degrees, seen in a horizontal plane, from the first work direction,
switching the output unit to the work position, and
starting the metering when the agricultural implement is located in the second work direction.

32. Method according to claim 30, wherein said negative work depth is obtained at field lift of the agricultural implement.

33. Method according to claim 30, wherein said adjustment of the work depth is carried out with the aid of a central adjustment mechanism, common to the agricultural implement, for adjusting the work depth.

34. Method according to claim 30, wherein said adjustment of the work depth is carried out by acting substantially simultaneously on the respective actuator arranged on each output unit.
